(19) United States
(12) Patent Application Publication
(10) Pub. No.: US 2014/0046655 A1
(43) Pub. Date: Feb. 13, 2014

(54) SYSTEMATIC PRESENTATION OF THE CONTENTS OF ONE OR MORE DOCUMENTS

(71) Applicant: Index Logic, LLC, San Diego, CA (US)

(72) Inventors: Susan Jo Paulson ROZOK, La Jolla, CA (US); Peter ROZOK, La Jolla, CA (US)

(73) Assignee: Index Logic, LLC, San Diego, CA (US)

(21) Appl. No.: 14/057,838

(22) Filed: Oct. 18, 2013

Related U.S. Application Data
(63) Continuation of application No. 12/792,474, filed on Jun. 2, 2010, now abandoned.
(60) Provisional application No. 61/183,466, filed on Jun. 2, 2009.

(51) Int. Cl. G06F 17/28

(52) U.S. Cl. CPC G06F 17/28
USPC 704/9

(57) ABSTRACT

A method of systematically presenting the contents of at least one document, comprising: (a) a user providing an electronic version of at least one document to a computer; (b) a user accepting or modifying noise words generated by a computer module; (c) generating a list of every non-noise word by means of a computer module wherein the list indicates every page on which a non-noise word appears; and (d) displaying the entire list of non-noise words. In some embodiments, the list of non-noise words further indicates the number of times a word occurs on a page. In some embodiments, the list of non-noise words further indicates each line on which a non-noise word appears.

### CROSS-REFERENCE

This application claims priority to U.S. patent application No. 12/792,474 filed Jun. 2, 2010, which claims the benefit of U.S. Provisional Application No. 61/183,466, filed Jun. 2, 2009, both of which are incorporated herein by reference in their entireties.

### BACKGROUND OF THE INVENTION

An index is a listing of the contents of a document according to subject matter. In certain instances, an index identifies the location in a document of references to people, places and events, and concepts selected by an editor as being of interest to a reader of the document.

### SUMMARY OF THE INVENTION

Disclosed herein, in certain embodiments, is a method of systematically presenting the contents of at least one document, comprising: (a) a user providing an electronic version of at least one document to a computer; (b) a user accepting or modifying noise words generated by a computer module; (c) generating a list of every non-noise word by means of a computer module wherein the list indicates every instance which a non-noise word appears; and (d) displaying the entire list of non-noise words. In some embodiments, the list indicates every page on which a non-noise word appears, or the time at which a non-noise word appears. In some embodiments, providing an electronic version of a document comprises retrieving a document from electronic memory, uploading a document, downloading a document, or scanning a document. In some embodiments, the noise words are selected from the group consisting of: prepositions, definite articles, indefinite articles, and pronouns. In some embodiments, the noise words are customizable. In some embodiments, a noise word is any word that appears more than about 50 times in the document. In some embodiments, a noise word is any word that constitutes more than about 1% of the document. In some embodiments, the method further comprises displaying a user-defined number of words preceding and succeeding one or more user-specified non-noise words. In some embodiments, the method further comprises generating a second list of words based on the proximity of a first word to a second word. In some embodiments, the document is a written document. In some embodiments, the document is bound or unbound. In some embodiments, the document is a visual file, an audio file, or a combination thereof.

Disclosed herein, in certain embodiments, is an index, comprising a list of every non-noise word in a document wherein the list indicates every instance at which a non-noise word appears. In some embodiments, the list indicates every page on which a non-noise word appears, or the time at which a non-noise word appears. In some embodiments, the document is a written document. In some embodiments, the document is bound or unbound. In some embodiments, the document is a visual file, an audio file, or a combination thereof.

Disclosed herein, in certain embodiments, is a method of systematically presenting the contents of at least one document, comprising: (a) a user providing an electronic version of at least one document to a computer; (b) a user accepting or modifying noise words generated by a computer module; (c) generating a list of every non-noise word by means of a computer module wherein the list indicates every instance which a non-noise word appears; and (d) displaying the entire list of non-noise words. In some embodiments, the list indicates every page on which a non-noise word appears. In some embodiments, the list indicates the time at which a non-noise word appears. In some embodiments, the list of non-noise words further indicates the number of times a word occurs on a page. In some embodiments, the list of non-noise words further indicates each line on which a non-noise word appears. In some embodiments, the method comprises one document. In some embodiments, the method comprises two or more documents. In some embodiments, the method comprises two or more related documents. In some embodiments, providing an electronic version of a document comprises retrieving a document from electronic memory, uploading a document, downloading a document, or scanning a document. In some embodiments, providing an electronic version of a document comprises retrieving a document from volatile memory. In some embodiments, providing an electronic version of a document comprises retrieving a document from non-volatile memory. In some embodiments, providing an electronic version of a document comprises scanning a document and applying optical character recognition to the scanned document. In some embodiments, the noise words are selected from the group consisting of: prepositions, definite articles, indefinite articles, and pronouns. In some embodiments, the noise words are customizable. In some embodiments, a noise word is any word that appears more than about 50 times in the document, more than about 100 times in the document, more than about 150 times in the document, more than about 200 times in the document, more than about 250 times in the document, or more than about 300 times in the document. In some embodiments, a noise word is any word that constitutes more than about 1% of the document, more than about 2% of the document, more than about 3% of the document, more than about 4% of the document, more than about 5% of the document, more than about 10% of the document, or more than about 20% of the document. In some embodiments, a non-noise word is a morpheme. In some embodiments, a non-noise word is an inflectional root. In some embodiments, a non-noise word is a digit or a cardinal numeral. In some embodiments, a non-noise word is an acronym (e.g., ABC, CBS). In some embodiments, a non-noise word is a symbol (e.g., %, $, @). In some embodiments, the list of non-noise words is arranged alphabetically. In some embodiments, the list of non-noise words is arranged numerically. In some embodiments, the list of non-noise words is clustered into categories. In some embodiments, the list of non-noise words is memorialized in print. In some embodiments, the list of non-noise words is memorialized in print and affixed to a document. In some embodiments, the list of non-noise words is stored in computer memory. In some embodiments, the list of non-noise words is stored in volatile computer memory. In some embodiments, the list of non-noise words is stored in non-volatile computer memory. In some embodiments, the list of non-noise words is electronically displayed. In some embodiments, the list of non-noise words is electronically displayed and is hypertext. In some embodiments, the list of non-noise words is electronically displayed and each page number comprises a hyperlink. In some embodiments, a user's activating a hyperlink results in the indicating of the corresponding non-noise word. In some embodiments, a user's activating a hyperlink results in the indicating of all corresponding non-noise words. In some embodiments, the method further comprises indicating a user-defined number of words preceding and succeeding one or more user-specified words. In some embodiments, the method further comprises generating a second list of words based on the proximity of a first word to a second word. In some embodiments, the method further comprises: (a) a user inputting a search query comprising one or more non-noise words into a computer module; and (b) indicating every instance of the non-noise word in the one or more documents by means of a computer module. In some embodiments, the search query further comprises a user inputting the number of words separating two or more words. In some embodiments, the display format of the list of non-noise words is customizable. In some embodiments, the list of non-noise words is compressed. In some embodiments, the list of non-noise words is compressed at a customizable compression ratio. In some embodiments, the display format of document is customizable. In some embodiments, the document is compressed. In some embodiments, the document is compressed at a customizable compression ratio. In some embodiments, the document is bound or unbound. In some embodiments, the document is a periodical. In some embodiments, the document is a newspaper, magazine, or journal. In some embodiments, the document is a fictional narrative. In some embodiments, the document is a short story, an anthology of short stories, a novella, a novel, a script. In some embodiments, the document is a work of non-fiction. In some embodiments, the document is a almanac, an autobiography, a biography, a diary, a digest, an encyclopedia, an essay (or collection of essays), a history, a letter (or collection of letters), a criticism (e.g., literary criticism), a memoir, a monograph (i.e., work intended to be a complete and detailed exposition of a substantial subject), an outline, a treatise (i.e., a systematic exposition of the principles of a subject), a statute (or collection of statutes), a textbook, a travelogue, a user manual, a prayer book, a missal, an album (e.g., a stamp album, or a photo album), a hymnal, a cookbook, a musical score, a documentary script, a map (e.g., an antique map), or a combination thereof. In some embodiments, the document is a visual file, an audio file, or a combination thereof.

Disclosed herein, in certain embodiments, is a system for systematically presenting the contents of at least one document, comprising: (a) a computer module for providing an electronic version of at least one document to a computer; (b) a computer module for identifying noise words; (c) a computer module for generating a list of every non-noise word wherein the list indicates every page on which a non-noise word appears; (d) a computer module for displaying the entire list; and (e) a computer for running the computer modules. In some embodiments, the system further comprises a computer module for retrieving a document from the volatile memory of a computer. In some embodiments, the system further comprises a computer module for retrieving a document from the non-volatile memory of a computer. In some embodiments, the system further comprises a computer module for scanning a document. In some embodiments, the system further comprises a computer module for applying optical character recognition to the scanned document. In some embodiments, the system further comprises a computer module for customizing noise words. In some embodiments, the system further comprises a computer module for arranging the non-noise words alphabetically. In some embodiments, the system further comprises a computer module for clustering the non-noise words into categories. In some embodiments, the system further comprises a computer module for printing the list. In some embodiments, the system further comprises a computer module for storing the list in computer memory. In some embodiments, the system further comprises a computer module for storing the list in volatile computer memory. In some embodiments, the system further comprises a computer module for storing the list in non-volatile computer memory. In some embodiments, the system further comprises a computer module for generating a second list of words based on the proximity of one word to another. In some embodiments, the system further comprises a computer module for displaying a user-defined number of words preceding and succeeding one or more user-specified words. In some embodiments, the system further comprises a computer module for compressing the list of non-noise words. In some embodiments, the system further comprises a computer module for compressing the document.

Disclosed herein, in certain embodiments, is an index, comprising a list of every non-noise word wherein the list indicates every page on which a non-noise word appears. In some embodiments, the index further comprises the number of times a word occurs on a page. In some embodiments, the index further comprises each line on which a non-noise word appears. In some embodiments, the list of non-noise words comprises non-noise words from one document. In some embodiments, the list of non-noise words comprises non-noise words from two or more documents. In some embodiments, the list of non-noise words comprises non-noise words from two or more related documents. In some embodiments, the list of non-noise words is arranged alphabetically. In some embodiments, the list of non-noise words is arranged numerically. In some embodiments, the list of non-noise words is clustered into categories. In some embodiments, the list of non-noise words is memorialized in print. In some embodiments, the list of non-noise words is memorialized in print and affixed to a document. In some embodiments, the list of non-noise words is stored in computer memory. In some embodiments, the list of non-noise words is stored in volatile computer memory. In some embodiments, the list of non-noise words is stored in non-volatile computer memory. In some embodiments, the list of non-noise words is electronically displayed. In some embodiments, the list of non-noise words is electronically displayed and is hypertext. In some embodiments, the list of non-noise words is electronically displayed and each page number comprises a hyperlink. In some embodiments, a user's activating a hyperlink results in the indicating of the corresponding non-noise word. In some embodiments, a user's activating a hyperlink results in the indicating of all corresponding non-noise words. In some embodiments, the display format of the list of non-noise words is customizable. In some embodiments, the list of non-noise words is compressed. In some embodiments, the list of non-noise words is compressed at a customizable compression ratio. In some embodiments, the display format of document is customizable. In some embodiments, document is compressed. In some embodiments, the document is compressed at a customizable compression ratio. In some embodiments, the document is bound or unbound. In some embodiments, the document is a periodical. In some embodiments, the document is a newspaper, magazine, or journal. In some embodiments, the document is a fictional narrative. In some embodiments, the document is a short story, an anthology of short stories, a novella, a novel, a script. In some embodiments, the document is a work of non-fiction. In some embodiments, the document is a almanac, an autobiography, a biography, a diary, a digest, an encyclopedia, an essay (or collection of essays), a history, a letter (or collection of letters), a criticism (e.g., literary criticism), a memoir, a monograph (i.e., work intended to be a complete and detailed exposition of a substantial subject), an outline, a treatise (i.e., a systematic exposition of the principles of a subject), a statute (or collection of statutes), a textbook, a travelogue, a user manual, a prayer book, a missal, an album (e.g., a stamp album, or a photo album), a hymnal, a cookbook, a musical score, a documentary script, a map (e.g., an antique map), or a combination thereof. In some embodiments, the document is a visual file, an audio file, or a combination thereof.

### DETAILED DESCRIPTION OF THE INVENTION

Disclosed herein, in certain embodiments, is a method of systematically presenting the contents of at least one document, comprising: (a) a user providing an electronic version of at least one document to a computer; (b) a user's accepting or modifying noise words generated by a computer module; (c) generating a list of every non-noise word by means of a computer module wherein the list indicates every instance which a non-noise word appears; and (d) displaying the entire list of non-noise words. In some embodiments, an end user utilizes the method. In some embodiments, the end user generates a document (e.g., a publishing house). In some embodiments, the end user is any person that possesses a document (e.g., a consumer that has purchased a document).

### Index

Disclosed herein, in certain embodiments, is a method of systematically presenting the contents of at least one document, comprising: (a) a user providing an electronic version of at least one document to a computer; (b) a user accepting or modifying noise words generated by a computer module; and (c) generating a list of every non-noise word by means of a computer module wherein the list indicates every page on which a non-noise word appear.

In some embodiments, the list of non-noise words further indicates the number of times a word occurs on a page. For example, if the word “Westphalia” appears three times on page 2 and 5 times on page 3, the list of non-noise words would indicate:

### Westphalia 2 (3), 3 (5)

Any format and/or symbol is used to indicate the number of times a word appears on a page; the format in the preceding sentence is an arbitrary choice and is not intended to be limiting.

In some embodiments, the list of non-noise words further indicates each line on which a non-noise word appears. For example, if the word “Westphalia” appears on page 2 at lines 5, 7, and 12, and on page 3 at line 13, the list of non-noise words would indicate:

### Westphalia 2:5, 2:7, 2:12, 3:13

Any format and/or symbol is used to indicate the line on which a non-noise word appears on a page; the format in the preceding sentence is an arbitrary choice and is not intended to be limiting.

In some embodiments, the method further comprises generating a second list of words based on the proximity of a first word to a second word. In some embodiments, a user specifies the first word, the second word, and proximity of the first word to the second word. For example, the second list consists of every occurrence of:

### Treaty “Within One Word of” Westphalia

In some embodiments, there is a pre-populated menu (e.g., a drop-down list) that lists choices of proximity (e.g., within 1 word; within 2 words, within 3 words, within 4 words) and the user selects a proximity from the list. In some embodiments, the user types in the proximity de novo (e.g., the user enters Treaty /1 Westphalia; Treaty /2 Westphalia). Any format and/or symbol is used to indicate proximity; “word1 /proximity word2” is an arbitrary format and is not intended to be limiting.

Disclosed herein, in certain embodiments, is a method of systematically presenting the contents of at least one document, comprising: (a) a user providing an electronic version of at least one document to a computer; (b) a user accepting or modifying noise words generated by a computer module; and (c) generating a list of every non-noise word by means of a computer module wherein the list indicates the place and/or time at which a non-noise word appears. For example, if the word “Westphalia” appears in a movie at 1 hour and 4 minutes, at 1 hour and 5 minutes, and 1 hour and 10 minutes the list of non-noise words would indicate:

### Westphalia 1:04, 1:05, 1:10

Further, by way of example only, if the word “freedom” appears in the lyrics to a song at 4 minutes and 6 seconds the list of non-noise words would indicate:

### Freedom 4:06

Additionally, by way of example only, if the word “commissario” appears in the lyrics to an opera in Act 1, scene 7 the list of non-noise words would indicate:

### Commissario 1:7

By way of example only, the list of non-noise words could further indicate the exact time the word “commissario” appears:

### Commissario 1:7 (4:30)

Any format and/or symbol is used to indicate the place and/or time at which a non-noise word appears; the formats in any of the preceding examples are arbitrary choices and are not intended to be limiting.

In some embodiments, the list of non-noise words is arranged alphabetically (e.g., a, b, c, d, e, f, g). In some embodiments, the list of non-noise words is arranged in reverse alphabetical order (g, f, e, d, c, b, a). In some embodiments, the list of non-noise words is arranged numerically (e.g., 1, 2, 3, 4, 5, 6, 7, 8, 9). In some embodiments, the list of non-noise words is arranged both alphabetically and numerically (e.g., 1, 2, 3, 4, 5, 6, 7, 8, 9, a, b, c, d, e, f, g).

In some embodiments, the list of non-noise words is further organized according to the author-defined sections (e.g., chapters, parts, tracks, movements) of the document. In some embodiments, the list of non-noise words is further organized by chapter. In some embodiments, the list of non-noise words is further organized by scene. In some embodiments, the list of non-noise words is further organized by track (e.g., the non-noise words of a CD are organized according to the track; e.g., track 1, track 2, track 3). In some embodiments, the list of non-noise words is further organized by movement. In some embodiments, the list of non-noise words is further organized by subject categories.

In some embodiments, the user defines the method of organization (e.g., alphabetically, reverse alphabetical order, numerically, numerically and then alphabetically, alphabetically and then numerically, by chapter). In some embodiments, the user selects the organizing principle from a pre-populated menu (e.g., a drop down menu).

In some embodiments, the user limits the list of non-noise words displayed in the index. In some embodiments, the user selects the non-noise words to display by selecting an option from a pre-populated menu (e.g., a drop-down menu). In some embodiments, the user limits the list of non-noise words according to the letter with which the word starts (e.g., the list only displays non-noise words that begin with “k”). In some embodiments, the user limits the list of non-noise words according to the author-defined section (e.g., the list only displays non-noise words found in chapter 15).

### Documents

As used herein, a “document” is a physical representation of a body of information. In some embodiments, a document is visible marks (e.g., ink marks, graphite marks, marker marks, crayon marks, colored pencil marks, charcoal marks, wax marks, pastel marks, chalk marks, paint marks, conté marks, silverpoint marks) on one or more pieces of a two-dimensional or three-dimensional medium (e.g., paper, canvas, wood, fabric). In some embodiments, a document is an electronic representation of information (e.g., a DVD, a CD, an e-book, a digital audio file). In some embodiments, the document is a digital image of marks on one or more pieces of a two-dimensional or three-dimensional medium (e.g., paper, canvas, wood, fabric).

As used herein, “paper” is any material made of a collection of fibers (e.g., cellulose pulp derived from wood, rags or grasses) that are interwoven. In some embodiments, a document comprises one sheet of paper. In some embodiments, a document comprises more than one sheet of paper.

In some embodiments, a document is bound. As used herein, a “bound document” is sheets of paper that are fastened together. In some embodiments, the document is bound by hardcover binding (i.e., the sheets are surrounded by rigid covers and are stitched in the spine). In some embodiments, the document is bound by a punch and bind binding (e.g., wire binding, twin loop binding, double loop binding, comb binding, velobind, spiral binding, coil binding, GBC Proclick, or ZipBind). In some embodiments, the document is bound by thermally activated binding (e.g., perfect binding, thermal binding, cardboard article binding, tape binding, or unibind binding). In some embodiments, the document is bound by stitched or sewn binding (e.g., sewn binding, or saddle-stitching).

In some embodiments, the document is unbound. In some embodiments, an “unbound document” is sheets of paper that are not fastened together. In some embodiments, an “unbound document” is sheets of paper that are not permanently bound together (e.g., bound by a paperclip, a staple, or a binder clip). In some embodiments, an “unbound document” is on pieces of a two-dimensional or three-dimensional medium (e.g., paper, canvas, wood, fabric) that are in a file.

In some embodiments, the document is a fictional narrative. In some embodiments, the document is a short story, an anthology of short stories, a novella, a novel, a script, or a combination thereof. In some embodiments, the document is a part-publication (i.e., a unified work that is published in pieces; e.g., the original publication of the Pickwick Papers).

In some embodiments, the document is a work of non-fiction. In some embodiments, the document is an almanac, an autobiography, a biography, a diary, a digest, an encyclopedia, an essay (or collection of essays), a history, a letter (or collection of letters), a criticism (e.g., literary criticism), a memoir, a monograph (i.e., work intended to be a complete and detailed exposition of a substantial subject), an outline, a treatise (i.e., a systematic exposition of the principles of a subject), a statute (or collection of statutes), a textbook, a travelogue, a user manual, a prayer book, a missal, an album (e.g., a stamp album, or a photo album), a hymnal, a cookbook, a script for a documentary, a musical score, a libretto, or a combination thereof.

In some embodiments, the document is a visual file, an audio file, or a combination thereof. In some embodiments, the document is a visual file (e.g., JPEG, MPEG, MPEG-2, H.264/MPEG-4 AVC, and SMPTE VC-1). In some embodiments, the document is an audio file (e.g., MP3, AIFF, WAV, MPEG-4, AAC and Lossless).

In some embodiments, the document is a periodical. As used herein, a “periodical” is a published work that appears in a new edition on a regular schedule and is intended to be published indefinitely. In some embodiments, the periodical is published daily, on alternate days, semi-weekly, weekly, bi-weekly (i.e., every fortnight), monthly, bi-monthly, quarterly, triannually, semi-annually, or a combination thereof. In some embodiments, the document is a newspaper (e.g., the Wall Street Journal, the New York Times) magazine (the Economist), newsletter, literary journal (e.g., the North American Review, the Yale Review), or a learned journal (e.g., Nature, Science, Lancet).

In some embodiments, the method comprises one document. In some embodiments, the method comprises two or more documents. In some embodiments, the method comprises two or more related documents. In some embodiments, the document is a collection of volumes (e.g., an encyclopedia). In some embodiments, the document is a series (i.e., a set of documents that should be read in a specific order; e.g., The Lord of the Rings trilogy or the Harry Potter series) or sequence (i.e., a set of documents that may be read in any sequence or independently; e.g., the Foundation series by Isaac Asimov).

### Retrieving

In some embodiments, providing an electronic version of a document comprises retrieving a document from electronic memory, uploading a document, downloading a document, or scanning a document.

In some embodiments, providing an electronic version of a document comprises retrieving a document from electronic memory. In some embodiments, providing an electronic version of a document comprises retrieving a document from volatile memory. As used herein, “volatile memory” means computer memory that requires electricity to maintain the stored information. In some embodiments, the volatile memory is random access memory (RAM), dynamic random access memory (DRAM), or static random access memory (SRAM).

In some embodiments, providing an electronic version of a document comprises retrieving a document from electronic memory. In some embodiments, providing an electronic version of a document comprises retrieving a document from non-volatile memory. As used herein, “non-volatile memory” means computer memory that retains the stored information in the absence of electricity. In some embodiments, the non-volatile memory is read-only memory, flash memory, a magnetic computer storage device (e.g., hard disks, floppy disks, and magnetic tape), or optical discs.

In some embodiments, providing an electronic version of a document comprises retrieving a document from cache. As used herein, “cache” is a computer memory where frequently accessed data is stored for rapid access.

In some embodiments, providing an electronic version of a document comprises scanning a document. In some embodiments, providing an electronic version of a document comprises scanning a document and applying optical character recognition to the scanned document. Document scanning or image scanning is the action or process of converting text and graphic paper documents, photographic film, photographic paper or other files to digital images. Pictures are normally stored in image formats such as uncompressed Bitmap, “non-lossy” (lossless) compressed TIFF and PNG, and “lossy” compressed JPEG. Documents are best stored in TIFF or PDF format;

As used herein, “optical character recognition” or OCR means the translation of an image (e.g., a .gif, or a .pdf) of text into machine-editable text (e.g., .doc). In some embodiments, the machine-editable text is 100% accurate as compared to the image. In some embodiments, the machine-editable text is 99% accurate. In some embodiments, the machine-editable text is 95% accurate. In some embodiments, the machine-editable text is 90% accurate. In some embodiments, the machine-editable text is 85% accurate. In some embodiments, the machine-editable text is 80% accurate. In some embodiments, accuracy is determined by correct spelling. In some embodiments, accuracy is determined by word context.

### Noise Words

In some embodiments, the noise words are selected from the group consisting of: prepositions, definite articles, indefinite articles, and pronouns. The particular embodiments discussed below are illustrative only and not intended to be limiting.

In some embodiments, the noise word is an adposition. As used herein, an “adposition” means a word or phrase that combines syntactically with a phrase and indicates how that phrase should be interpreted in the surrounding context. In some embodiments, the adposition is a preposition, a postposition; or a circumposition. In some embodiments, the adposition is selected from the group consisting of: aboard; about; above; across; after; against; along; alongside; amid; amidst; among; amongst; around; as; aside; at; athwart; atop; barring; before; behind; below; beneath; beside; besides; between; beyond; but; by; circa; concerning; despite; down; during; except; failing; following; for; from; in; inside; into; like; minus; near; next; notwithstanding; of; off; on; onto; opposite; out; outside; over; pace; past; per; plus; regarding; round; save; since; than; through; throughout; till; times; to; toward; towards; under; underneath; unlike; lies; up; upon; versus; via; with; within; without; worth; according to; ahead of; aside from; because of; close to; due to; except for; far from; inside of; instead of; near to; next to; out from; out of; outside of; owing to; prior to; pursuant to; regardless of; subsequent to; that of; as far as; as well as; by means of; in accordance with; in addition to; in case of; in front of; in lieu of; in place of; in spite of; on account of; on behalf of; on top of; with regard to.

In some embodiments, the noise word is an article. In some embodiments, the noise word is a definite article. As used herein, “definite article” means a word used before singular and plural nouns that refers to a particular member of a group. In some embodiments, the definite article is “the”. In cases where articles are classified as feminine, masculine, and neutral, definite articles include all forms of the definite article.

In some embodiments, the noise word is an indefinite article. As used herein, an “indefinite article” means a word used before singular nouns that refers to any member of a group. In cases where articles are classified as feminine, masculine, and neutral, indefinite articles include all forms of the indefinite article.

In some embodiments, the noise word is a partitive article. As used herein, a partitive article is a word that indicates an indefinite quantity of a mass noun.

In some embodiments, the noise word is a pronoun. As used herein, a “pronoun” is a pro-form (i.e., a word or expression that stands in for another where the meaning is recoverable from the context) that substitutes for a noun (or noun phrase) with or without a determiner. In some embodiments, the pronoun is selected from the group consisting of: I; me; myself; mine; we; us; ourselves; ourself; ours; our; you; yourself; yours; you; yourselves; thou; thee; thyself; thine; thy; he; him; himself; his; she; her; herself; hers; it; itself; its; one; oneself; one's; they; them; themself; themselves; theirs; their.

In some embodiments, a noise word is a word that appears more than about 50 times in the document, more than about 100 times in the document, more than about 150 times in the document, more than about 200 times in the document, more than about 250 times in the document, or more than about 300 times in the document. In some embodiments, a noise word is a word that appears more than a user specified number of times in the document. In some embodiments, a user selects the specified number of times from a pre-populated menu. In some embodiments, the user enters the specified number of times de novo.

In some embodiments, a noise word is a word that constitutes more than about 1% of the document, more than about 2% of the document, more than about 3% of the document, more than about 4% of the document, more than about 5% of the document, more than about 10% of the document, or more than about 20% of the document. In some embodiments, a noise word is a word that constitutes more than a user specified percentage of the document.

In some embodiments, the noise words are customizable by a user. In some embodiments, the user classifies an additional word as a noise word (e.g., “cell” in a biology textbook; “treaty” in a history textbook). In some embodiments, the user reclassifies a noise word as a non-noise word. In some embodiments, the user manually types in (enters de novo) the word to be classified as a noise word. In some embodiments, the user selects the word to be classified as a noise word from a list generated by a computer module (e.g., a pre-populated menu).

### Non-Noise Words

In some embodiments, a non-noise word is a root word. As used herein, a “root word” means the primary lexical unit of a word, which carries the most significant aspects of semantic content and cannot be reduced into smaller constituents. In some embodiments, a non-noise word is a morpheme. As used herein, a “morpheme” is the smallest linguistic unit that has semantic meaning. In some embodiments, the non-noise word is a free morpheme (i.e., a morpheme that can stand alone). In some embodiments, the non-noise word is a bound morpheme (i.e., a morpheme that is always used with a free morpheme).

In some embodiments, a non-noise word is an inflectional root. As used herein, an “inflectional root” is a word minus its inflectional endings, but with its lexical endings in place.

In some embodiments, the non-noise word is a lemma. As used herein, a “lemma” is a form of a word that is chosen by convention to represent a set of words.

In some embodiments, a non-noise word is a numeral. In some embodiments, the non-noise word is a word that represents a number (e.g., one, two, three, four, five six, seven, eight, nine, ten). In some embodiments, the non-noise word is a digit. As used herein, a digit is a symbol used to represent numbers (e.g., 1, 2, 3, 4, 5, 6, 7, 8, 9, 0).

In some embodiments, a non-noise word is a musical theme (e.g., a recurring musical fragment or succession of notes). In some embodiments, a non-noise word is a melody, a motif, a leitmotif, a figure, a subject, a ritornello, or a rondo.

In some embodiments, a non-noise word is picture (e.g., a visual frame from a movie) or a series of pictures (e.g., a scene or a sequence). As used herein, a “scene” is a part of a story that takes place in a single location. For example, the non-noise word is any scene comprising a car chase. As used herein, a “sequence” is a series of scenes which form a distinct narrative unit.

### Presentation and Storage of the Index

In some embodiments, the list of non-noise words is memorialized (i.e., a record is created) in print. In some embodiments, the list of non-noise words is memorialized in print and affixed to a document. In some embodiments, the list of non-noise words is memorialized in print and provided as a supplement to a document (e.g., as a supplement to a textbook, a supplement to a musical CD, a supplement to a DVD). As used herein, a “supplement” is a separate document that complements (i.e., adds information to) another preceding or concurrent document.

In some embodiments, the list of non-noise words is stored in computer memory. In some embodiments, the list of non-noise words is stored in volatile computer memory. In some embodiments, the list of non-noise words is stored in non-volatile computer memory.

In some embodiments, the list of non-noise words is stored in non-volatile computer memory (e.g., read-only memory, flash memory, a magnetic computer storage device, or an optical disc), and provided to a third party (i.e., a customer of a publisher) as a supplement to a document (e.g., as a supplement to a textbook). In some embodiments, the list of non-noise words is stored on a server and access is provided (e.g., sold) to a third party (e.g., via an internet connection). In some embodiments, the list of non-noise words is stored on an optical disc (e.g., a Blu-Ray disc, DVD, or a CD) and the optical disc is provided (e.g., sold) to a third party. In some embodiments, the list of non-noise words is stored on a magnetic storage device and the magnetic storage device is provided (e.g., sold) to a third party. In some embodiments, the index is stored in a computer module that further comprises the document (i.e., the list of non-noise words is provided as part of an e-book, a DVD, or a Blu-Ray disc).

In some embodiments, the display format of the list of non-noise words is customizable by a user. In some embodiments, the user specifies the font size of the list of non-noise words. In some embodiments, the user specifies the number of pages to be displayed on a single sheet of paper (e.g., 8.5×11) or an electronic representation of a sheet of paper. In some embodiments, 2 pages are displayed on a single sheet of paper. In some embodiments, 4 pages are displayed on a single page. In some embodiments, 6 pages are displayed on a single page.

In some embodiments, the list of non-noise words is compressed. As used herein, “compress” (and variants thereof, e.g., compressed, compressing) means to encode information using less information-bearing units (e.g., bits) than would normally be required. In some embodiments, the list of non-noise words is zipped. In some embodiments, the list of non-noise words is compressed at a customizable compression ratio. In some embodiments, the list of non-noise words is compressed at a ratio of about of 2:1, 3:1, 4:1, 5:1, 10:1, 15:1, or 20:1.

### Presentation and Storage of the Document

In some embodiments, the display format of the full (i.e., entire or complete) document is customizable by a user. In some embodiments, the user specifies the font size of the document. In some embodiments, the user specifies the number of pages to be displayed on a single sheet of paper (e.g., 8.5×11) or an electronic representation of a sheet of paper. In some embodiments, 2 pages are displayed on a single sheet of paper. In some embodiments, 4 pages are displayed on a single page. In some embodiments, 6 pages are displayed on a single page.

In some embodiments, the document is compressed. As used herein, “compress” (and variants thereof, e.g., compressed, compressing) means to encode information using less information-bearing units (e.g., bits) than would normally be required. In some embodiments, the document is zipped. In some embodiments, the document is compressed at a customizable compression ratio. In some embodiments, the document is compressed at a ratio of about of 2:1, 3:1, 4:1, 5:1, 10:1, 15:1, or 20:1.

### Hypertext

In some embodiments, the list of non-noise words is electronically displayed. In some embodiments, each non-noise word further comprises a hyperlink. In some embodiments, the hyperlink links the non-noise word in the list of non-noise words and the first occurrence of the non-noise word in the document. In some embodiments, the system further comprises a computer module that generates a hyperlink.

In some embodiments, the list of non-noise words is electronically displayed. In some embodiments, the list of non-noise words further comprises a list of (a) every page on which a non-noise word appears, (b) every author-defined section in which a non-noise word appears, or (c) every time at which a non-noise word appears. In some embodiments, each page number, author-defined section, or time further comprises a hyperlink. In some embodiments, the hyperlink links a non-noise word and the first occurrence of the non-noise word on a page or in an author-defined section.

In some embodiments, a user activates a hyperlink (e.g., by clicking on the hyperlink). In some embodiments, activating a hyperlink takes a user to the first occurrence of a non-noise word in the document.

In some embodiments, activating a hyperlink further results in the indicating of all occurrences of the non-noise word in the document. In some embodiments, activating a hyperlink results in the indicating of all occurrences of the non-noise word on a page. In some embodiments, activating a hyperlink results in the indicating of all occurrences of the non-noise word in a chapter. As used herein, indicate (and all forms thereof, e.g., indicate, indicating, indicated) means to differentiate a non-noise word of interest from all noise words, and all non-noise words not of interest. In some embodiments, indicating comprises changing the font of a non-noise word. In some embodiments, indicating comprises changing the font size of a non-noise word. In some embodiments, indicating comprises changing the font style of a non-noise word (e.g., by bolding, italicizing, or underlining). In some embodiments, indicating comprises highlighting a non-noise word.

In some embodiments, the hyperlink is an embedded link (i.e., a hyperlink embedded in a text object); an inline link (i.e., a hyperlink that displays remote content without the need for embedding the content); a hot area (i.e., a list of coordinates relating to a specific area on a screen created in order to hyperlink areas of the image to various destinations, disable linking via negative space around irregular shapes, or enable linking via invisible areas); random accessed linking data (i.e., links retrieved from a database or variable containers in a program when the retrieval function is from user interaction or non-interactive process); a hardware accessed link (i.e., a link that activates directly via an input device (e.g., keyboard, microphone, remote control) without the use of a graphical user interface); or combinations thereof. In some embodiments, the hyperlink is an embedded link.

In some embodiments, the method further comprises a means for navigating between occurrences of a non-noise word. In some embodiments, activating the means for navigating between occurrences of a non-noise word takes a user to the immediately preceding occurrence of the non-noise word. In some embodiments, activating the means for navigating between occurrences of a non-noise word takes a user to the immediately succeeding occurrence of the non-noise word. In some embodiments, the means for navigating between occurrences of a non-noise word is a computer module.

By way of example only, a user activates an embedded hyperlink that takes the user to the first instance of a non-noise word. Next, the user activates the means for navigating to the occurrence of the non-noise word immediately succeeding the first occurrence of the non-noise word. The user continues activating the means for navigating to the next occurrence of the non-noise word until the user reaches the end of the document.

### Search Engine

In some embodiments, the method further comprises: (a) a user inputting a search query comprising one or more non-noise words into a computer module; and (b) indicating every instance of the non-noise word in the one or more documents by means of a computer module.

Boolean Logic

In some embodiments, the search query utilizes Boolean logic. As used herein, “Boolean logic” means a logical operation that is used to combine search terms. Boolean search operators include, but are not limited to, “AND”, “OR” and “NOT”. In some embodiments, the user selects a Boolean search operator from a pre-populated menu (e.g., the menu contains the options: NEAR, AND, OR). In some embodiments, the user enters the proximity de novo (e.g., the user inputs (e.g., types) the word “AND”).

In some embodiments, “AND” narrows a search by requiring that a search result contain all search terms connected by “AND”. For example, a search formatted as: “treaty AND westphalia” will only return results that contain both the terms “treaty” and “westphalia”.

In some embodiments, “NEAR” narrows a search by requiring that a search result contain all search terms connected by “NEAR” within a certain proximity to each other. For example, a search formatted as: “treaty NEAR westphalia” will return results that contain both the terms “treaty” and “westphalia” within a certain proximity to each other. In some embodiments, the proximity is user defined. In some embodiments, the user selects the proximity from a pre-populated menu (e.g., the menu contains the options” within 5 words, within 10 words, within 20 words, within 50 words, within 100 words, on the same page, in the same chapter). In some embodiments, the user enters the proximity de novo (e.g., “NEAR 10 words” or “/10”).

In some embodiments, “OR” broadens a search by permitting that a search result contain any of the search terms connected by “OR”. For example, a search formatted as: “treaty OR westphalia” will return results that contain either the term “treaty” or the term “westphalia”.

Any format and/or symbol is used to indicate the Boolean search operator; the formats in the preceding paragraphs are arbitrary choices and are not intended to be limiting.

Fuzzy Matching

In some embodiments, the search query utilizes fuzzy matching. As used herein, “fuzzy matching” means a search method whereby the search returns results that approximate a user inputted search term. In certain instances, fuzzy matching returns a result if the result lies within a predefined edit distance (i.e., Levenshtein distance). In some embodiments, a fuzzy search returns results that are obtained by insertion (e.g., changing cot to coat), deletion (e.g. changing coat to cot), substitution (e.g. changing coat to cost), transposition (i.e., switching the position of two or more letters), or combinations thereof. In some embodiments, the edit distance is user defined.

Query Expansion

In some embodiments, the search engine utilizes query expansion. As used herein, “query expansion” means a search method whereby a search term (i.e., seed query) is reformulated to improve retrieval. In some embodiments, query expansion comprises finding synonyms of words, finding morphological forms of words, fixing spelling errors, or combinations thereof. In some embodiments, the method of query expansion is user defined (e.g., the user selects from expansion based on finding synonyms of words, finding morphological forms of words, fixing spelling errors, or combinations thereof).

Further Search Options

In some embodiments, the search query further comprises a user indicating the author-defined sections (e.g., chapters, parts, tracks, movements) of the document. By way of example, the user searches for the word “Westphalia” in chapter 10. In some embodiments, an author-defined section from a pre-populated menu (e.g., a drop down menu).

In some embodiments, the method further comprises indicating a user-defined number of words preceding and succeeding one or more user-specified words. For example, user specifies that 10 words proceeding and 10 words succeeding Treaty of Westphalia be indicated. As discussed above, to indicate means to differentiate a desired set of words from the background (e.g., the remainder of the document). In some embodiments, indicating comprises changing the font of a non-noise word. In some embodiments, indicating comprises changing the font size of a non-noise word. In some embodiments, indicating comprises changing the font style of a non-noise word (e.g., by bolding, italicizing, or underlining). In some embodiments, indicating comprises highlighting a non-noise word.

System

In some embodiments, the system further comprises a means for (a) inputting a search query comprising one or more non-noise words into a computer module; (b) identifying results that match the search query, and (c) indicating every instance of the non-noise word in the one or more documents. In some embodiments, the means for identifying results that match the search query comprises Boolean logic, fuzzy matching, and/or query expansion.

### Report

In some embodiments, the method further comprises: generating a summary of the contents of the index (i.e., a report). In some embodiments, the system further comprises a computer module that generates a summary of the contents of the index (i.e., a report).

In some embodiments, a user defines the content of the report. In some embodiments, the report indicates the number of times a non-noise word appears throughout the document. In some embodiments, the report indicates the author-defined sections in which a non-noise word appears. In some embodiments, the report indicates the number of times a non-noise word appears in an author-defined section.

In some embodiments, the report is generated automatically. In some embodiments, the report is generated after a user engages a computer module (i.e., after the user requests the report be generated). In some embodiments, the report is attached to the index (e.g., at the end of the index).

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of generating an index identifying the location of information of interest to a reader for at least one document, comprising:
a. providing a computer module for allowing a user to provide an electronic version of at least one document to a computer;
b. providing a computer module for allowing a user to add a noise word or accept, reclassify, or modify:
(i) noise words generated by a computer module, and
(ii) the computer module instructions used to generate the noise words;
or any combinations thereof;
c. generating a list of noise words by means of a computer module;
d. generating a list of every non-noise word by means of a computer module, wherein the list indicates every instance which a non-noise word appears, wherein the non-noise words are not morphemes; and
e. displaying the entire list of non-noise words as an index for the reader;
wherein the list of noise words and list of non-noise words are generated utilizing the instructions in response to a user providing an electronic version of at least one document.

2. The method of claim 1, wherein the list indicates every page on which a non-noise word appears, or the time at which a non-noise word appears.

3. The method of claim 1, wherein providing an electronic version of a document comprises retrieving a document from electronic memory, uploading a document, downloading a document, or scanning a document.

4. The method of claim 1, wherein the noise words are selected from the group consisting of:
prepositions, definite articles, indefinite articles, and pronouns.

5. The method of claim 1, wherein the noise words are customizable.

6. The method of claim 1, wherein a noise word is any word that appears more than 50 times in the document.

7. The method of claim 1, wherein a noise word is any word that constitutes more than 1% of the document.

8. The method of claim 1, further comprising displaying a user-defined number of words preceding and succeeding one or more user-specified non-noise words.

9. The method of claim 1, further comprising generating a second list of words based on the proximity of a first word to a second word.

10. The method of claim 1, wherein the document is a written document.

11. The method of claim 1, wherein the document is bound or unbound.

12. The method of claim 1, wherein the document is a visual file, an audio file, or a combination thereof.

13. An index that is modifiable by a user, comprising (a) a list of every non-noise word in a document, wherein the non-noise words are not morphemes; and (b) an indication of every instance at which a non-noise word appears; wherein the index is stored in a computer-readable memory; and wherein the user can modify (a) the list of non-noise words, and (b) the computer module instructions used to generate the list of non-noise words.

14. The index of claim 13, wherein the list indicates every page on which a non-noise word appears, or the time at which a non-noise word appears.

15. The index of claim 13, wherein the document is a written document.

16. The index of claim 13, wherein the document is bound or unbound.

17. The index of claim 13, wherein the document is a visual file, an audio file, or a combination thereof.

18. The method of claim 1, wherein the computer module for allowing a user to accept or to modify the computer module instructions used to generate the noise words allows a user to modify the threshold number or percentage of times a word must appear in order to be classified as a noise word.
